(19) United States
(12) Patent Application Publication
(10) Pub. No.: US 2013/0138934 A1
(43) Pub. Date: May 30, 2013

(54) LOADING CONFIGURATION INFORMATION

(71) Applicants: Fei X. Lin, Shanghai (CN); Nan X. Mei, Shanghai (CN); Nathan C. Skalsky, Durham, NC (US); Jun Y. Wang, Shanghai (CN); Dao Q. Yang, Shanghai (CN)

(72) Inventors: Fei X. Lin, Shanghai (CN); Nan X. Mei, Shanghai (CN); Nathan C. Skalsky, Durham, NC (US); Jun Y. Wang, Shanghai (CN); Dao Q. Yang, Shanghai (CN)

(73) Assignee: International Business Machines Corporation, Armonk, NY (US)

(21) Appl. No.: 13/570,614

(22) Filed: Aug. 9, 2012

(30) Foreign Application Priority Data
Nov. 29, 2011 (CN) 201110401242.8

(51) Int. Cl. G06F 9/00

(52) U.S. Cl. 713/1

(57) ABSTRACT

Embodiments of the present invention relate to a method and apparatus for loading configuration information. The method for loading configuration information according to one embodiment of the present invention comprises: obtaining a first digest from a baseboard management controller BMC, wherein the first digest is generated according to first configuration information stored in BMC; comparing the first digest with a second digest locally stored in a host system, wherein the second digest is generated according to second configuration information locally stored in the host system, and the second configuration information is configuration information loaded in the last boot of the host system; and in response to determining that the first digest differs from the second digest, obtaining the first configuration information from BMC for overwriting the second configuration information, so as to load the first configuration information in the course of booting the host system.

### CROSS-REFERENCE TO RELATED APPLICATIONS

This application claims priority under 35 U.S.C. §119 to Chinese Patent Application No. 201110401242.8 filed on Nov. 29, 2011, the entire text of which is specifically incorporated by reference herein.

### BACKGROUND OF THE INVENTION

1. Field of the Invention

The present invention relates to computer technology, and more specifically, to a method and apparatus for loading configuration information.

2. Background of the Related Art

A modern server may be divided into two main, relatively independent systems, i.e., a host system and a baseboard management controller (MBC). The host system is a general computer system, which typically includes a processor, volatile memory, non-volatile memory, a mainboard, etc. Various input/output systems may be connected to the mainboard, such as a keyboard, a mouse, a display, a network interface and so on. The BMC mainly functions to implement remote control and may operate when the host is partially shut down. The BMC stores configuration information locally subsequent to obtaining it from a console through communication connection with the console. The host system loads the configuration information from the BMC and applies the configuration information.

The mainboard of a computer system is usually provided with power-on self-test (POST) firmware that is used for checking whether respective hardware devices are normal when the computer system is booted. Typical POST firmware is a basic input output system (BIOS). In the above server with a remote control function, BIOS is further responsible for loading information from the BMC. In the course of POST, BIOS sends a configuration information request to the BMC; upon receipt of the request, the BMC packages the configuration information in a configuration information response with a BIOS-identifiable format and then sends the response to BIOS; upon receipt of the configuration information response, BIOS loads the configuration information and performs the subsequent POST step.

As a new type of POST firmware, a unified extensible firmware interface (UEFI) is gradually replacing the traditional BIOS at present. UEFI supports a much larger address space, so that more complex configuration information may be processed. As a result, data transfers between the BMC and the POST firmware become more frequent, the amount of data transfers also becomes increasingly larger.

### BRIEF SUMMARY OF THE INVENTION

A method for loading configuration information according to one embodiment of the present invention comprises: obtaining a first digest from a baseboard management controller BMC, wherein the first digest is generated according to first configuration information stored in the BMC; comparing the first digest with a second digest locally stored in a host system, wherein the second digest is generated according to second configuration information locally stored in the host system, and the second configuration information is configuration information loaded in the last boot of the host system; and in response to determining that the first digest differs from the second digest, obtaining the first configuration information from the BMC for overwriting the second configuration information, so as to load the first configuration information in the course of booting the host system.

An apparatus for loading configuration information according to another embodiment of the present invention comprises: a digest obtaining module configured to obtain a first digest from a baseboard management controller BMC, wherein the first digest is generated according to first configuration information stored in the BMC; a digest comparing module configured to compare the first digest with a second digest locally stored in a host system, wherein the second digest is generated according to second configuration information locally stored in the host system, and the second configuration information is configuration information loaded in the last boot of the host system; and a configuration information obtaining module configured to, in response to determining that the first digest differs from the second digest, obtain the first configuration information from the BMC for overwriting the second configuration information, so as to load the first configuration information in the course of booting the host system.

### BRIEF DESCRIPTION OF THE DRAWINGS

FIG. 1 is a block diagram of an exemplary computer system which is applicable to implement embodiments of the present invention;

FIG. 2 is a flowchart of a method for loading configuration information according to one embodiment of the present invention;

FIG. 3 is a flowchart of a method for loading configuration information according to another embodiment of the present invention; and

FIG. 4 is a block diagram of an apparatus for loading configuration information according to one embodiment of the present invention.

### DETAILED DESCRIPTION OF THE PREFERRED EMBODIMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or one embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instruction means which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring to the figures, description is given below to the present invention in the context of specific embodiments. Such description is only for the purpose of illustration and not intended to limit the scope of the present invention.

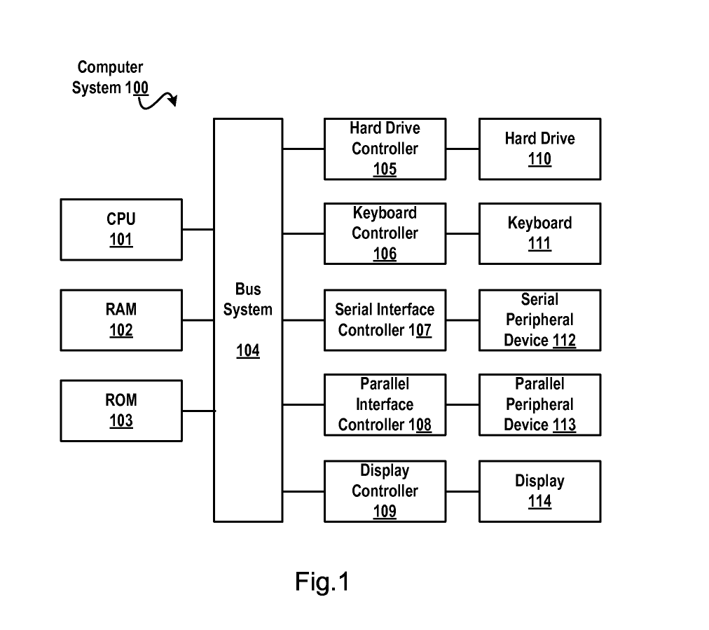

FIG. 1 is a block diagram of an exemplary computer system 100 which is applicable to implement the embodiments of the present invention. As illustrated in FIG. 1, the computer system 100 may include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among the above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as illustrated in FIG. 1 is provided only for exemplary purposes rather than any limitation to the present invention. In some cases, some devices may be added to or removed from the computer system 100 based on specific situations.

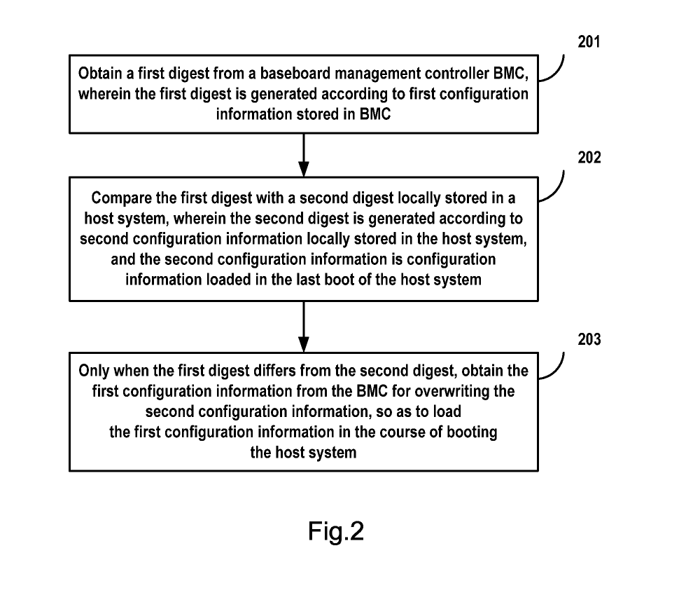

FIG. 2 is a flowchart of a method for loading configuration information according to one embodiment of the present invention.

In step 201, a first digest is obtained from a baseboard management controller BMC, wherein the first digest is generated according to first configuration information stored in the BMC.

Those skilled in the art may use various algorithms to generate a digest of information, such as MD5, CRC, SHA1, etc. The algorithm being selected should ensure that in case of two different pieces of information, the probability where their respective summaries differ is greater than a certain collision probability threshold.

The first digest may be calculated by the BMC itself according to configuration information transferred from the console. Or the first digest may be calculated by the console according to the configuration information and then transferred to the BMC together with the configuration information.

The BMC may store the first digest in its storage module or calculate the first digest in real time upon receipt of a request to access the first digest.

In step 202, the first digest is compared with a second digest locally stored in a host system, wherein the second digest is generated according to second configuration information locally stored in the host system, and the second configuration information is the configuration information loaded in the last boot of the host system.

In a first boot of the host system, the second configuration information and the second digest are not locally present, or only default configuration information and the corresponding digest are present. In the first boot, the host system obtains the first configuration information from the BMC and stores it locally as the second configuration information. The host system may additionally obtain from the BMC the first digest corresponding to the first configuration information and store it locally as the second digest; or the host system may calculate the second digest according to the obtained first configuration information. In the latter case, similarly, the host system may store the second digest in its storage module or calculate the second digest in real time upon receipt of a request for accessing the second digest.

In a next boot, the host system locally stores the configuration information loaded in the last boot. Optionally, the host system further stores a digest of configuration information loaded in the last boot stored therein.

In step 203, in response to determining that the first digest differs from the second digest, the first configuration information is obtained from the BMC to overwrite the second configuration information, and the first configuration information is loaded in the course of booting the host system.

According to the definition of a digest (alternatively referred to as a hash value or a message digest), if the first digest differs from the second digest, it indicates that the first configuration information differs from the second configuration information. While configuring a server at a console, configuration information is first transferred to the BMC, so the first configuration information in the BMC is the latest configuration information. The server should be booted according to the first configuration information. At this point, the host system needs to obtain the first configuration information from the BMC. If configuration information is loaded in the course of the POST, then it is the POST firmware on the host system that obtains the first configuration information from the BMC. After obtaining the first configuration information, the host system loads the first configuration information in a boot on the one hand, and on the other hand, the host system locally stores the first configuration information.

In a next boot, if the digest of locally stored configuration information is identical to a digest of configuration information stored in the BMC, it indicates that the locally stored configuration information is the latest configuration information. In this case, the host system may directly load the locally stored configuration information in the course of a boot. As described above, the amount of data transferred between the BMC and the POST firmware increases greatly in applications of UEFI. If the time that is spent in obtaining configuration information from the BMC in the course of the POST is saved, then the boot can be accelerated.

In a further embodiment, configuration information may be divided into a plurality of configuration information files, and the foregoing steps may be performed with respect to each configuration information file. In other words, if a digest of a certain configuration information file stored in the host system is identical to a digest of a corresponding configuration information file stored in the BMC, then the configuration information file stored in the host system is directly loaded in the course of a boot; otherwise, a data transfer is initiated from the BMC to the host system with respect to the file. In this way, if a digest of a particular configuration information file stored in the host system differs from a digest of a corresponding configuration information file stored in the BMC, then only the corresponding configuration information file needs to be transferred from the BMC, rather than all configuration information files being transferred.

Since the BMC and the host system are two relatively independent systems, sometimes the BMC is not ready when the host system is booted. In this case, step 201 of obtaining the first digest from the BMC cannot be performed by the host system when the host system is booted. According to one embodiment of the present invention, it is possible to first suspend booting the host system and not to enter step 201 until access to the BMC is available.

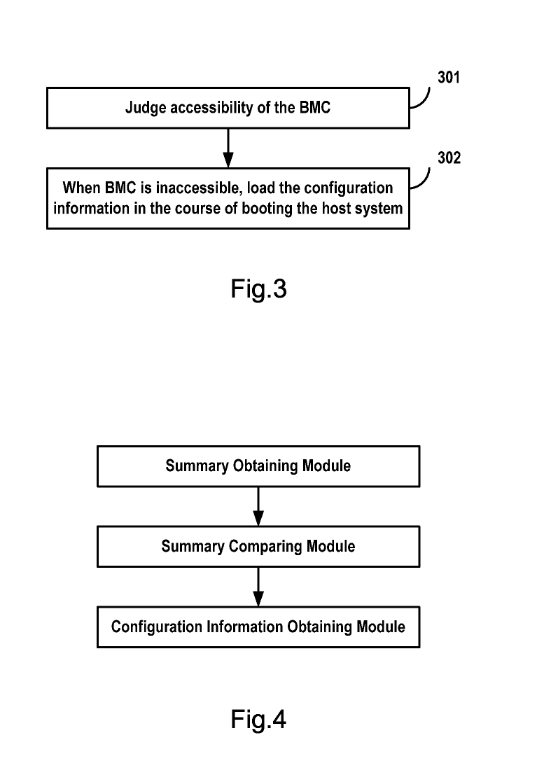

FIG. 3 is a method of loading configuration information according to another embodiment of the present invention. In step 301, accessibility of the BMC is judged. The host system may judge accessibility of the BMC in various manners. For example, the host system may perform detection by a heartbeat signal of the BMC. For another example, the host system may request to the BMC for the first digest. If no response from the BMC is obtained within a wait time threshold, then the BMC is considered inaccessible.

In step 302, when the BMC is inaccessible, the second configuration information is loaded in the course of booting the host system. If the BMC is accessible, then the first digest is directly obtained from the BMC according to step 301. When the BMC is inaccessible, since it is impossible to judge whether or not configuration information is changed, the host system is booted with the original configuration information, namely the second configuration information.

By means of such arrangement, the host system and the BMC may be booted simultaneously, rather than sequentially, so that the boot time for the host system is saved. Generally speaking, the reason why the BMC is inaccessible is that the BMC is also in an initialization because the BMC fails and needs to be rebooted so as to be recovered, or because the BMC needs to be rebooted so as to apply an update. If the configuration information is not changed, then actually the first configuration information does not need to be obtained from the BMC. The host system is firstly booted with the second configuration information, and after the BMC is accessible, a digest of configuration information is obtained from the BMC according to step 201 and a comparison is made according to step 202. In most cases, the configuration information will not be changed, so a comparison result obtained from step 202 is that the first digest is identical to the second digest. At this point, since the host system has loaded the second configuration information, subsequent booting steps may proceed directly. In rare cases, the configuration information is changed, so a comparison result obtained from 202 is that the first digest differs from the second digest. At this point, according to step 203, the changed configuration information or the changed configuration information file is transferred from the BMC, and the new configuration information is loaded in the course of a boot.

FIG. 4 is a block diagram of an apparatus for loading configuration information according to one embodiment of the present invention. The apparatus comprises the following modules: (1) a digest (or summary) obtaining module configured to obtain a first digest from a baseboard management controller BMC, wherein the first digest is generated according to first configuration information stored in the BMC; (2) a digest (or summary) comparing module configured to compare the first digest with a second digest locally stored in a host system, wherein the second digest is generated according to second configuration information locally stored in the host system, and the second configuration information is configuration information loaded in the last boot of the host system; and (3) a configuration information obtaining module configured to, in response to determining that the first digest differs from the second digest, obtain the first configuration information from the BMC for overwriting the second configuration information, so as to load the first configuration information in the course of booting the host system.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks illustrated in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although a detailed description has been presented above to the apparatus and methods of the present invention in conjunction with specific embodiments, the present invention is not limited to this. Various alterations, replacements and modifications may be made by those of ordinary skill in the art under the teaching of the specification and without departing from the spirit and scope of the present invention. It should be understood that all such alterations, replacements and modifications still fall within the protection scope of the present invention that is defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for loading configuration information, comprising:
obtaining a first digest from a baseboard management controller BMC, wherein the first digest is generated according to first configuration information stored in the BMC;
comparing the first digest with a second digest locally stored in a host system, wherein the second digest is generated according to second configuration information locally stored in the host system, and the second configuration information is configuration information loaded in the last boot of the host system; and
in response to determining that the first digest differs from the second digest, obtaining the first configuration information from the BMC for overwriting the second configuration information, so as to load the first configuration information in the course of booting the host system.

2. The method according to claim 1, wherein obtaining a first digest from a baseboard management controller BMC comprises:
judging accessibility of the BMC; and
in response to the BMC being accessible, obtaining the first digest from the BMC.

3. The method according to claim 2, further comprising:
in response to the BMC being inaccessible, loading the second configuration information in the course of booting the host system.

4. The method according to claim 3, further comprising:
continuing to judge accessibility of the BMC until the BMC is accessible.

5. The method according to claim 1, further comprising:
in response to determining that the first digest is identical to the second digest, loading the second configuration information in the course of booting the host system.

6. An apparatus for loading configuration information, comprising:
a digest obtaining module configured to obtain a first digest from a baseboard management controller BMC, wherein the first digest is generated according to first configuration information stored in the BMC;
a digest comparing module configured to compare the first digest with a second digest locally stored in a host system, wherein the second digest is generated according to second configuration information locally stored in the host system, and the second configuration information is configuration information loaded in the last boot of the host system; and
a configuration information obtaining module configured to, in response to determining that the first digest differs from the second digest, obtain the first configuration information from the BMC for overwriting the second configuration information, so as to load the first configuration information in the course of booting the host system.

7. The apparatus according to claim 6, wherein the digest obtaining module comprises:
a module configured to judge accessibility of the BMC; and
a module configured to obtain the first digest from the BMC in response to determining that the BMC is accessible.

8. The apparatus according to claim 7, further comprising:
a module configured to load the second configuration information in the course of booting the host system in response to determining that the BMC is inaccessible.

9. The apparatus according to claim 8, further comprising:
a module configured to continue to judge accessibility of the BMC until the BMC is accessible.

10. The apparatus according to claim 6, further comprising:
a module configured to load the second configuration information in the course of booting the host system in response to determining that the first digest is identical to the second digest.
